(19) United States
(12) Patent Application Publication
(10) Pub. No.: US 2024/0148007 A1
(43) Pub. Date: May 9, 2024

(54) MAGNETIC INTERCHANGEABLE DOUGH FILLING AND CUTTING ASSEMBLY

(71) Applicant: Tonya Jacob, Bossier City, LA (US)

(72) Inventor: Tonya Jacob, Bossier City, LA (US)

(21) Appl. No.: 17/983,475

(22) Filed: Nov. 9, 2022

(51) Int. Cl. A21C 11/10; A47J 43/20

(52) U.S. Cl. CPC A21C 11/106; A47J 43/20

(57) ABSTRACT

A magnetic interchangeable dough filling and cutting assembly for interchanging a plurality of shaping attachments includes a plurality of attachments being magnetic and used for creating a shape within a semisolid material. Each of the attachments has a shape surface and a mounting surface. The mounting surface of each of the attachments has a magnetic latching element. Furthermore, a handle has a mount for attaching to each of the attachments. The handle is a metal material having magnetic capabilities for retaining each of the attachments by magnetism. Additionally, the mount has a catching element for the magnetic latching element to be nested within wherein facilitating in securing each of the attachments to the mount of the handle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to dough scooping device and more particularly pertains to a new dough scooping device for interchanging a plurality of filling and cutting attachments.

### (2) Description of Related Art Including Information Disclosed Under 37 CFR 1.97 and 1.98

The prior art relates to dough scooping devices. The prior art includes a variety of dough scooping devices configured for forming a shape upon dough. Known prior art lacks a dough scooping device comprising a plurality of attachments coupling by magnetism to a handle for filling and cutting the dough.

### BRIEF SUMMARY OF THE INVENTION

An embodiment of the disclosure meets the needs presented above by generally comprising a plurality of attachments being magnetic and configured for creating a shape within a semisolid material. Each of the attachments has a shape surface and a mounting surface wherein the mounting surface of each of the attachments has a magnetic latching element. Furthermore, a handle has a mount for coupling to each of the attachments. The handle is a metal material having magnetic capabilities configured for retaining each of the attachments to the handle by magnetism. The handle is configured for being gripped by a hand of the user. Additionally, the mount has a catching element for the magnetic latching element to be nested within to secure each of the attachments to the mount of the handle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a magnetic interchangeable dough filling and cutting assembly according to an embodiment of the disclosure.

FIG. 2 is a front view of an embodiment of the disclosure.

FIG. 3 is a side view of an embodiment of the disclosure.

FIG. 4 is a top view of an embodiment of the disclosure.

FIG. 5 is a front isometric view of an embodiment of the disclosure.

FIG. 6 is a front view of an embodiment of the disclosure.

FIG. 7 is a left view of an embodiment of the disclosure.

FIG. 8 is a top view of an embodiment of the disclosure.

FIG. 9 is a detail view of an embodiment of the disclosure.

FIG. 10 is a side view of an embodiment of the disclosure.

FIG. 11 is a side view of an embodiment of the disclosure.

FIG. 12 is a side view of an alternative embodiment of the disclosure.

FIG. 13 is a side view of an alternative embodiment of the disclosure.

FIG. 14 is a side view of an alternative embodiment of the disclosure.

FIG. 15 is a side view of an alternative embodiment of the disclosure.

FIG. 16 is an in-use view of an alternative embodiment of the disclosure.

### DETAILED DESCRIPTION OF THE INVENTION

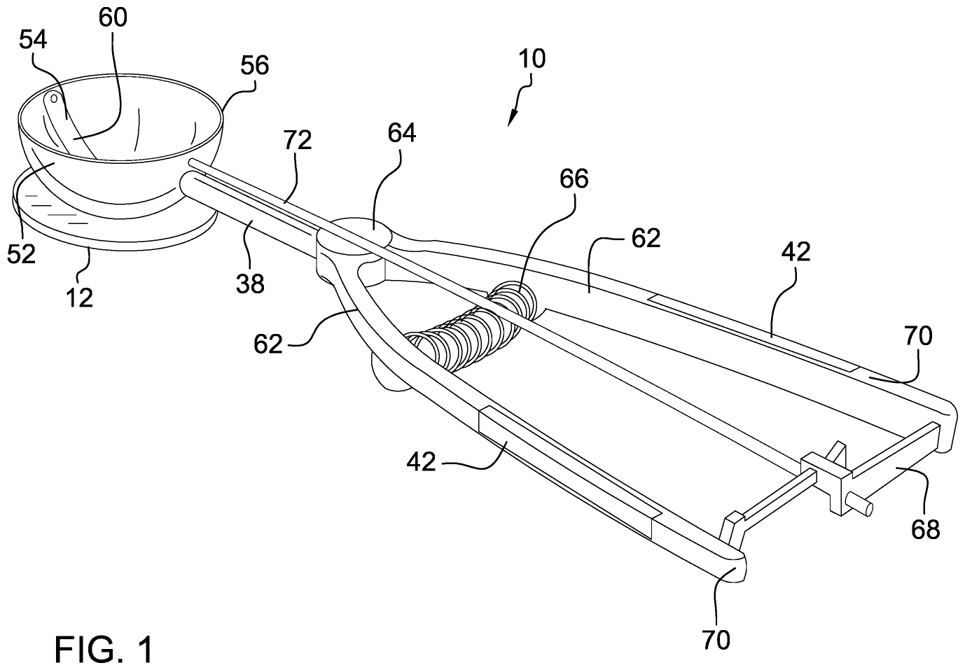

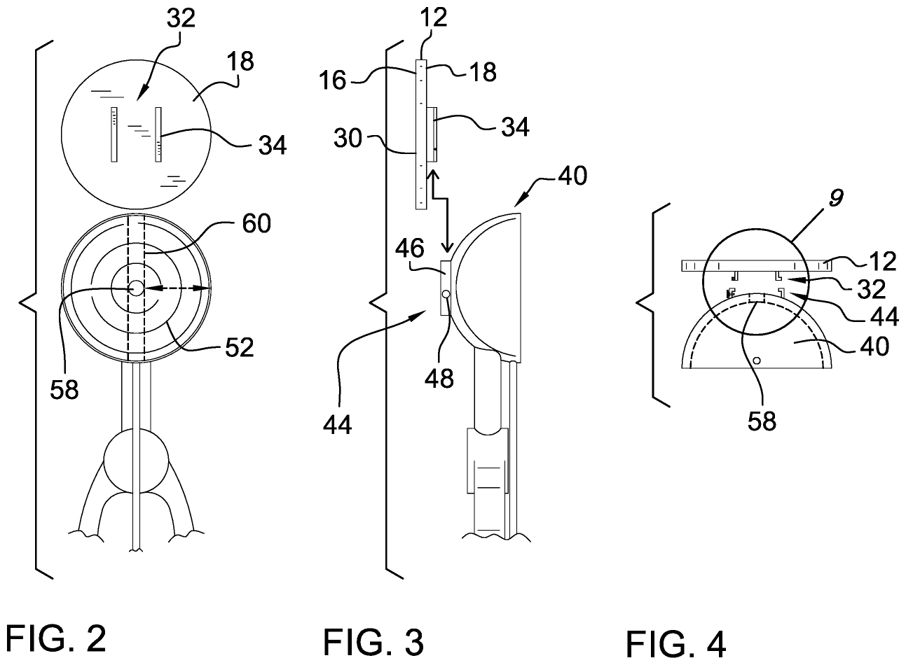

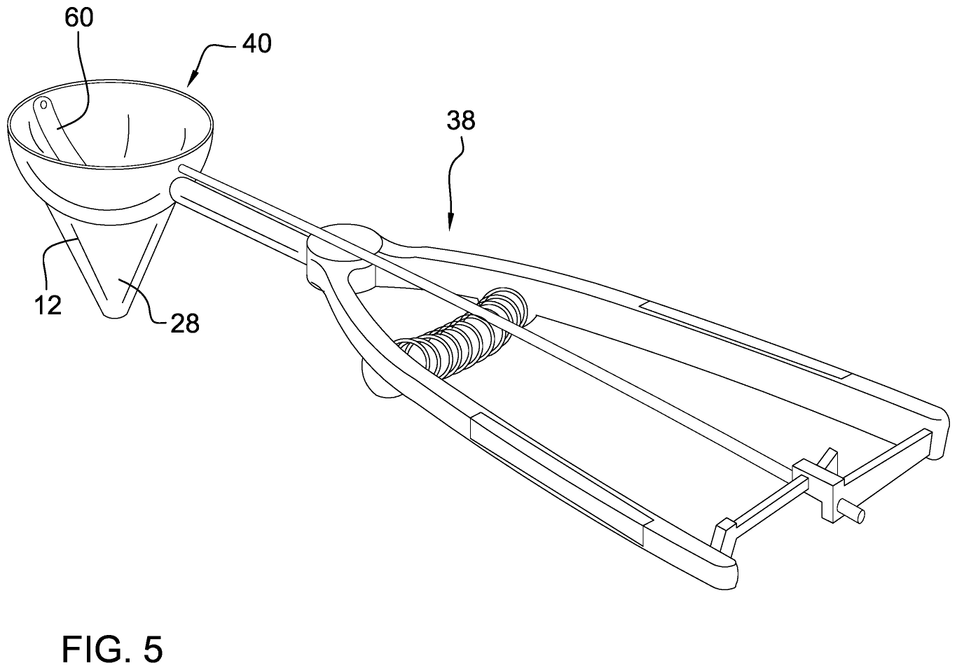

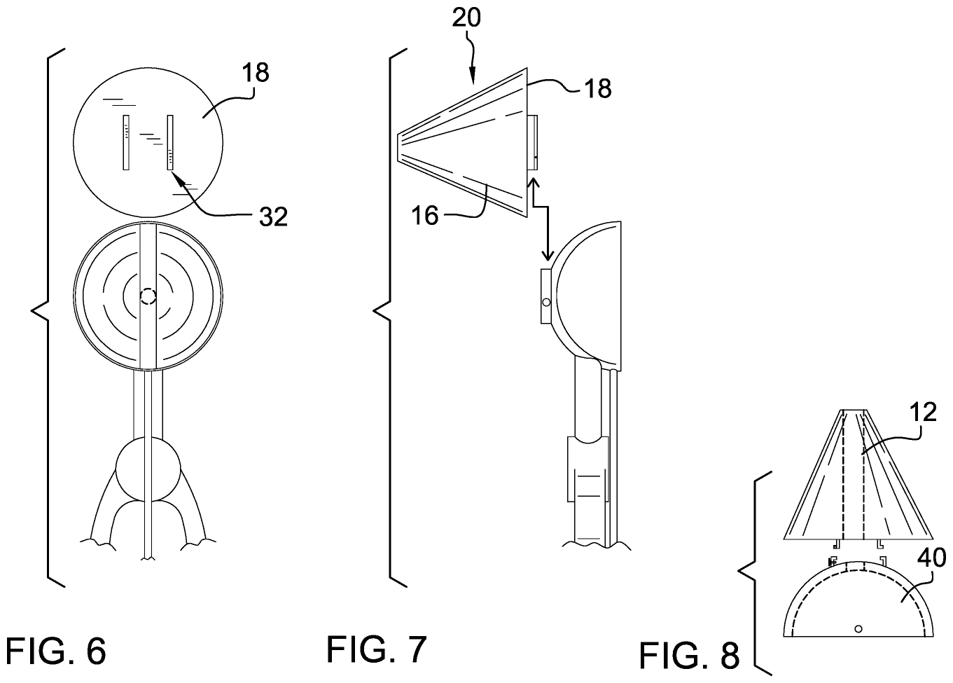

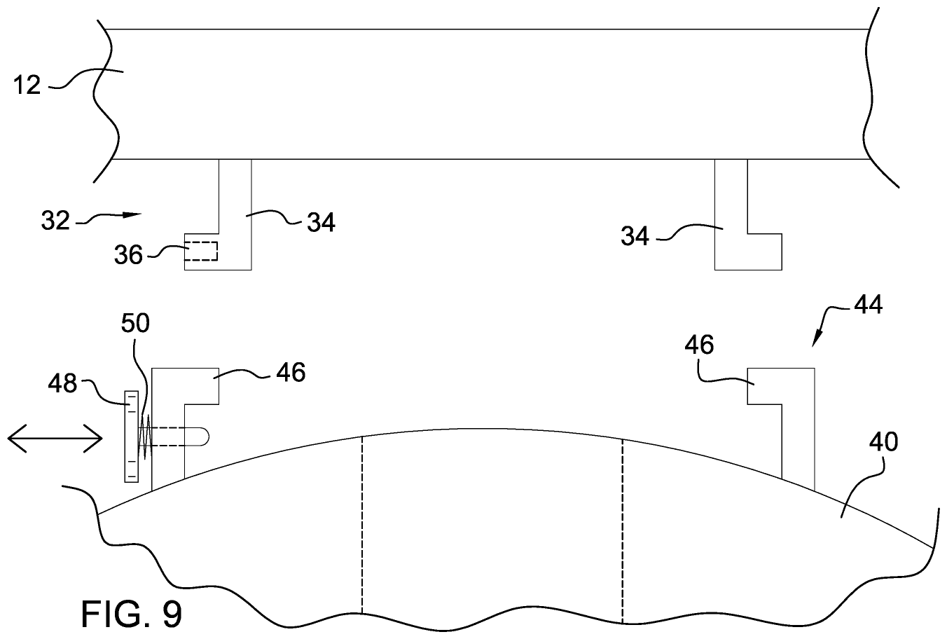

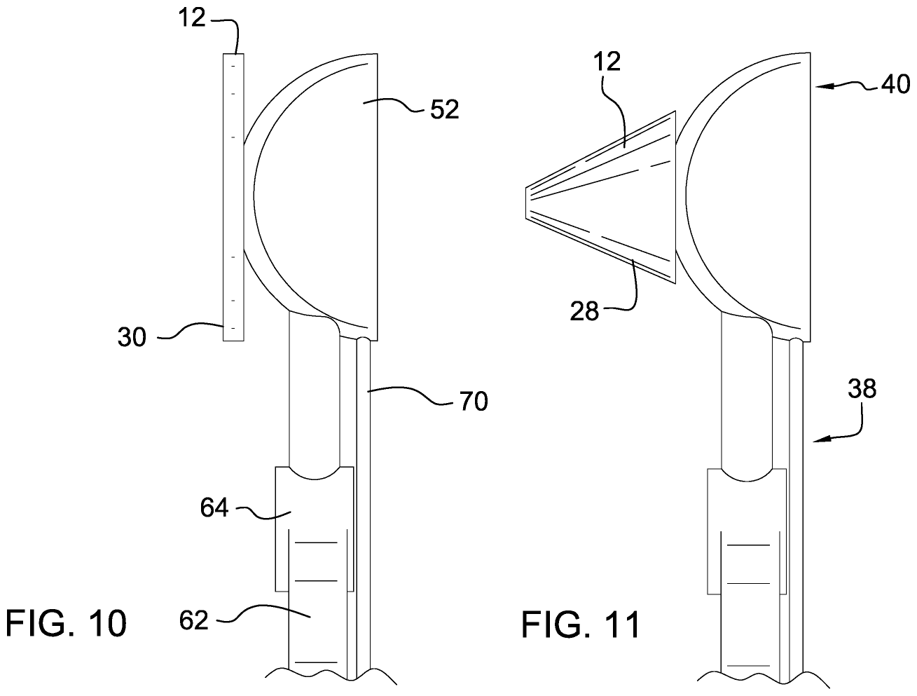

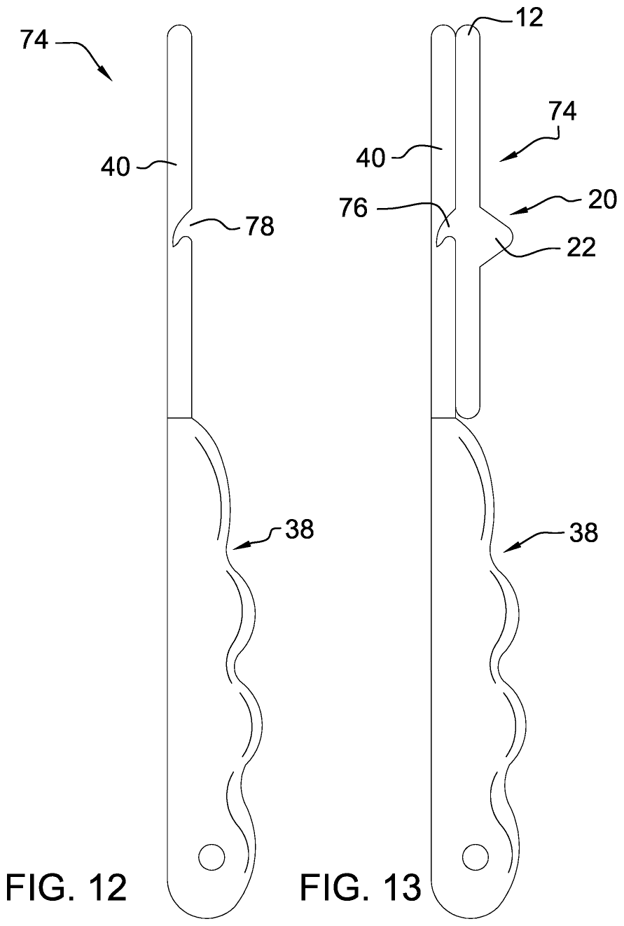

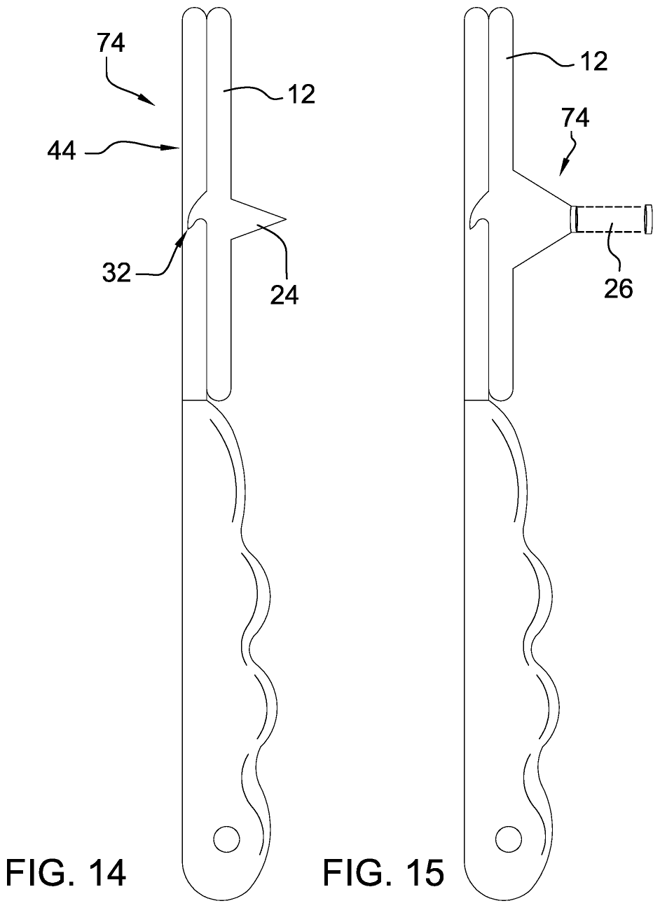

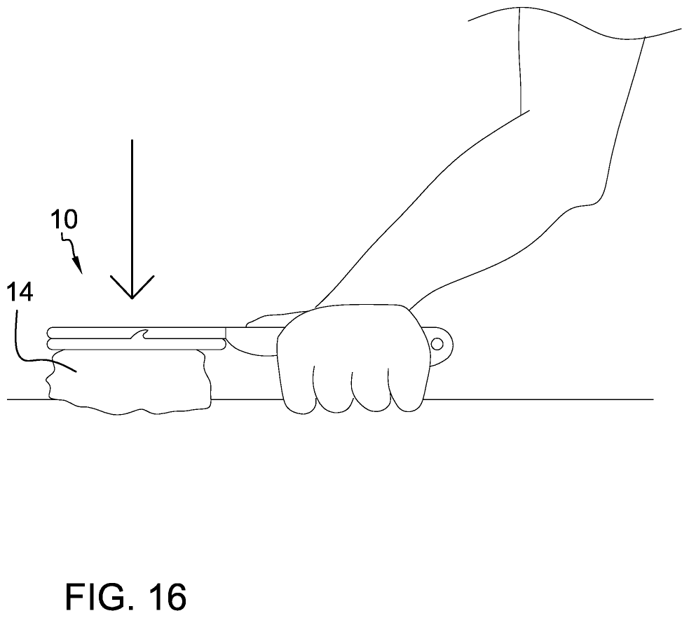

With reference now to the drawings, and in particular to FIGS. 1 through 16 thereof, a new dough scooping device embodying the principles and concepts of an embodiment of the disclosure and generally designated by the reference numeral 10 will be described.

As best illustrated in FIGS. 1 through 16, the magnetic interchangeable dough filling and cutting assembly 10 generally comprises a plurality of attachments 12 being magnetic. Each of the attachments 12 is configured for creating a shape within a semisolid material 14 which may comprise dough for a plurality of foods including bagels, donuts, cookies, cupcakes, or other pastries. Each of the attachments 12 has a circular disc shape and includes a shape surface 16 and a mounting surface 18. The shape surface 16 of each of the attachments 12 has a perimeter wall protruding out therefrom and a protrusion 20 configured for producing a shape within the semisolid material 14. The protrusion 20 of each of the attachments 12 is configured for being one from a group of structures including a round bump 22, a triangular point 24, a center-hole cutter 26, a funnel 28, and a flat plate 30. Alternately, the mounting surface 18 of each of the attachments 12 has a magnetic latching element 32 being a pair of tabs 34 having a cavity 36.

A handle 38 has a mount 40 for coupling to each of the attachments 12. The mount 40 is a metal material such as stainless steel having magnetic capabilities wherein the mount 40 is configured for retaining each of the attachments 12 to the handle 38 by magnetism. The handle 38 is configured for being gripped by a hand of the user and includes a non-slip grip 42 configured for being retained within the hand of the user. The mount 40 has a catching element 44 being complementary to the magnetic latching element 32 wherein the magnetic latching element 32 is nested within the catching element 44 for facilitating in securing each of the attachments 12 to the mount 40 of the handle 38. The catching element 44 is a pair of slots 46 including a release pin 48 having a spring 50 wherein the release pin 48 is spring loaded and complementary to the cavity 36 of the pair of tabs 34. The release pin 48 is biased towards pushing inward wherein being nested within the cavity 36 of the pair of tabs 34. The user can pull on the release pin 48 prior to sliding each of the attachments 12 off the mount 40 of the handle 38.

A scoop 52 is positioned on the mount 40 of the handle 38. The scoop 52 has a semi-spherical body including an interior 54 defining a space for the semisolid material 14 to be positioned within. The scoop 52 has a perimeter edge 56 defining an opening to the interior 54 of the scoop 52. The scoop 52 has an aperture 58 positioned in a center of said scoop and extending therethrough. Additionally, a scraper 60 is positioned within the interior 54 of the scoop 52. The scraper 60 is a semi-circular band movably positioned upon the aperture 58 to the perimeter edge 56 of the scoop 52. The scraper 60 is configured for rotating within said interior 54 of said scoop 52 to facilitate in removing the semisolid material 14 from the scoop 52.

A pair of clamps 62 is positioned on the handle 38. Each of the clamps 62 is coupled to each other by a hinge 64 configured for positioning the pair of clamps 62 from an open position to a closed position. An extension spring 66 is positioned between each of the clamps 62 and is configured for being biased towards the open position of the pair of clamps 62 wherein the extension spring 66 will push the pair of clamps 62 away from each other when force from the hand of the user is removed. A ratchet mechanism 68 is positioned at an end 70 of the pair of clamps 62. The ratchet mechanism 68 has a rod 72 being coupled to the scraper 60 of the scoop 52 wherein the ratchet mechanism 68 is configured for rotating the rod 72 thus rotating the scraper 60 within the interior 54 of the scoop 52.

An alternative embodiment 74 of the magnetic interchangeable dough shaping assembly 10 includes the plurality of attachments 12 and the handle 38 with the mount 40. The alternative embodiment 74 lacks the scoop 52 and the pair of clamps 62 wherein the handle 38 does not have scooping capabilities. Furthermore, the magnetic latching element 32 of each of the attachments 12 of the alternative embodiment 42 includes a hook 76 protruding out from the mounting surface 18. The catching element 44 of the mount 40 of the handle 12 includes an indent 78 being complementary to the hook 76 of the latching mechanism 32.

In use, the user couples the magnetic latching element 32 of each of the attachments 12 to the catching element 44 of the mount 40 of the handle 38. The user can use each of the attachments 12 to fill or cut within the semisolid material 14 using the protrusion 20 of the shape surface 16. The user can use the scoop 52 to remove individual pieces of the semisolid material 14, and the scraper 60 of the scoop 52 can removed the semisolid material 14 by engaging with the ratchet mechanism 68 of the pair of clamps 62 of the handle 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A magnetic interchangeable shaping attachment device configured for facilitating in shaping a semisolid, the magnetic interchangeable shaping attachment device comprising:
a plurality of attachments being magnetic, each of said attachments being configured for creating a shape within a semisolid material, each of said attachments having a shape surface and a mounting surface, said mounting surface of each of said attachments having a magnetic latching element;
a handle having a mount for coupling to each of said attachments, said mount being a metal material, said metal material having magnetic capabilities, said mount being configured for retaining each of said attachments to said handle by magnetism, said handle being configured for being gripped by a hand of the user, said mount having a catching element, said magnetic latching element being nested within said catching element for securing each of said attachments to said mount of said handle.

2. The magnetic interchangeable shaping attachment device of claim 1, wherein said semisolid material comprises dough.

3. The magnetic interchangeable shaping attachment device of claim 1, wherein each of said attachments has a circular disc shape including a perimeter wall protruding out therefrom.

4. The magnetic interchangeable shaping attachment device of claim 1, wherein said shape surface of each of said attachments has a protrusion configured for producing a shape within said semisolid material.

5. The magnetic interchangeable shaping attachment device of claim 1, wherein said magnetic latching element comprises a pair of tabs, said pair of tabs having a cavity.

6. The magnetic interchangeable shaping attachment device of claim 5, wherein said catching element is complementary to said magnetic latching element.

7. The magnetic interchangeable shaping attachment device of claim 6, wherein said catching element is a pair of slots, said pair of slots having a release pin, said release pin having a spring wherein said release pin being spring loaded, said release pin being complementary to said cavity of said pair of tabs.

8. The magnetic interchangeable shaping attachment device of claim 1, further including a scoop positioned on said mount of said handle, said scoop having a semi-spherical body, said scoop having an interior, said interior of said scoop defining a space for a semisolid material to be positioned within, said scoop having a perimeter edge, said perimeter edge defining an opening to said interior of said scoop, said scoop having an aperture extending therethrough.

9. The magnetic interchangeable shaping attachment device of claim 8, further including a scraper being positioned within said interior of said scoop, said scraper being a semi-circular band, said scraper being movably positioned upon said aperture of said scoop to said perimeter edge of said scoop.

10. The magnetic interchangeable shaping attachment device of claim 9, further including a pair of clamps being positioned on said handle, each of said clamps being coupled to each other by a hinge, said hinge being configured for positioning said pair of clamps from an open position to a closed position, an extension spring being positioned between each of said clamps, said extension spring being configured for being biased towards said open position of said pair of clamps.

11. The magnetic interchangeable shaping attachment device of claim 10, further including a ratchet mechanism being positioned at an end of said pair of clamps, said ratchet mechanism having a rod being coupled to said scraper of said scoop, said ratchet mechanism being configured for rotating said rod wherein rotating said scraper within said interior of said scoop.

12. A magnetic interchangeable shaping attachment device configured for facilitating in shaping a semisolid, the magnetic interchangeable shaping attachment device comprising:
a plurality of attachments being magnetic, each of said attachments being configured for creating a shape within a semisolid material, said semisolid material comprising dough, each of said attachments having a circular disc shape including a perimeter wall protruding out therefrom, each of said attachments having a shape surface and a mounting surface, said shape surface of each of said attachments having a protrusion configured for producing a shape within said semisolid material, said mounting surface of each of said attachments having a magnetic latching element, said magnetic latching element comprising pair of tabs, said pair of tabs having a cavity;
a handle having a mount for coupling to each of said attachments, said mount being a metal material, said metal material having magnetic capabilities, said mount being configured for retaining each of said attachments to said handle by magnetism, said handle being configured for being gripped by a hand of the user, said mount having a catching element, said catching element being complementary to said magnetic latching element, said magnetic latching element being nested within said catching element for securing each of said attachments to said mount of said handle, said catching element comprising a pair of slots, said pair of slots having a release pin, said release pin having a spring wherein said release pin being spring loaded, said release pin being complementary to said cavity of said pair of tabs;
a scoop positioned on said mount of said handle, said scoop having a semi-spherical body, said scoop having an interior, said interior of said scoop defining a space for a semisolid material to be positioned within, said scoop having a perimeter edge, said perimeter edge defining an opening to said interior of said scoop, said scoop having an aperture extending therethrough, a scraper being positioned within said interior of said scoop, said scraper being a semi-circular band, said scraper being movably positioned upon said aperture of said scoop to said perimeter edge of said scoop; and
a pair of clamps being positioned on said handle, each of said clamps being coupled to each other by a hinge, said hinge being configured for positioning said pair of clamps from an open position to a closed position, an extension spring being positioned between each of said clamps, said extension spring being configured for being biased towards said open position of said pair of clamps, a ratchet mechanism being positioned at an end of said pair of clamps, said ratchet mechanism having a rod being coupled to said scraper of said scoop, said ratchet mechanism being configured for rotating said rod wherein rotating said scraper within said interior of said scoop.
